(19) United States
(12) Patent Application Publication
(10) Pub. No.: US 2008/0249955 A1
(43) Pub. Date: Oct. 9, 2008

(54) System and method for creating customized weather derivatives

(75) Inventor: David Friedberg, San Francisco, CA (US)

Correspondence Address: CARR & FERRELL LLP, 2200 GENG ROAD, PALO ALTO, CA, 94303, US

(73) Assignee: WeatherBill, Inc.

(21) Appl. No.: 11/732,533

(22) Filed: Apr. 3, 2007

(51) Int. Cl. G06Q 40/00

(52) U.S. Cl. 705/36 R

(57) ABSTRACT

Exemplary systems and methods for creating customized weather derivatives are provided. In exemplary embodiments, a general weather derivative contract form is provided. A weather contract type selection within the general weather derivative contract form is received from a purchaser by a derivative seller system. A weather index term and a payout term based on the weather contract type selection are also received from the purchaser. The customized weather derivative based on the weather contract type selection, the weather index term, and the payout term is generated. In some embodiments, a pricing analysis based on the weather contract type selection, the weather index term, and the payout term is performed.

### CROSS-REFERENCE TO RELATED APPLICATIONS

The present application claims priority from U.S. patent application Ser. No. 11/611,111 filed Dec. 14, 2006 entitled “Systems and Methods for Automated Weather Risk Assessment,” and U.S. patent application Ser. No. 11/645,951 filed Dec. 26, 2006 entitled “Single Party Platform for Sale and Settlement of OTC Derivatives,” both of which are herein incorporated by reference.

### BACKGROUND OF THE INVENTION

1. Field of the Invention

Embodiments of the present invention relate generally to derivatives, and more particularly to creating customized weather derivatives.

2. Description of Related Art

Generally, derivatives are conditional financial instruments used by market participants to purchase or manage an asset. One use of derivatives is to remove risk from a situation. One form of derivatives is weather derivatives. Because weather can negatively impact revenue or costs for a business, weather derivatives may be used to reduce the impact that adverse weather may create. Alternately, weather derivatives can be used in speculation.

In prior art systems, a three party system for the sale of weather derivatives may be utilized. For example, an energy company may be in real time communication with a third party facilitator (e.g., Goldman Sachs) and an insurance company providing the derivatives for sale. Thus, information and terms are exchanged between the three parties in this communication system.

Additionally, weather derivatives are available for purchase via exchanges. For example, monthly weather derivatives may be exchanged on the Chicago Mercantile Exchange that cover one of 18 U.S. cities. These weather derivatives typically cover heating degree days (HDD), whereby a payout occurs for every degree that the average daily temperature is below 65° Fahrenheit during the term of the derivative, or cooling degree days (CDD), whereby a payout occurs for every degree that the average daily temperature is above 65° Fahrenheit during the term of the derivative.

Disadvantageously, exchange-traded weather derivatives are not customizable. For example, the weather station at which the weather measurement occurs, rules for creation of the underlying weather index, payout schemes, and durations of the derivative are limited.

Further, to purchase an existing weather derivative, such as a HDD weather derivative, purchasers are often required to call a broker, or lawyer, who prepares a contract for the specific weather derivative that the purchaser desires. There does not presently exist a contract or system that can accommodate the purchase and payout of a variety of different types of weather derivatives.

### SUMMARY OF THE INVENTION

Embodiments of the present invention provide a system and method for creating customized weather derivatives. The derivatives are customized based on terms provided or selected by the purchaser.

In various embodiments, a general weather derivative contract form is provided. A weather contract type selection within the general weather derivative contract form is received from a purchaser by a derivative seller system. A weather index term and a payout term based on the weather contract type selection are also received from the purchaser. The customized weather derivative based on the weather contract type selection, the weather index term, and the payout term is generated. In some embodiments, a pricing analysis based on the weather contract type selection, the weather index term, and the payout term is performed.

The purchaser may also provide a location term and a duration of contract term. The location term may comprise a weather station location. The duration of contract term can comprise a weekday/weekend selection.

The weather index term may comprise a weather parameter type and/or threshold terms. The payout term can comprise a payout amount for the customized weather derivative and/or a payout trigger term.

In various embodiments, a machine readable medium may have embodied thereon a program comprising instructions. The instructions can provide a method for creating a customized weather derivative in a network. The method can comprise providing a general weather derivative contract form, receiving a weather contract type selection within the general weather derivative contract form, receiving a weather index term and a payout term based on the weather contract type selection, and generating the customized weather derivative based on the weather contract type selection, the weather index term, and the payout term.

In various embodiments, a system for creating a customized weather derivative comprises a means for providing a general weather derivative contract form, an interface configured to receive a weather contract type selection, a weather index term and a payout term based on the weather contract type selection, and a processor configured to generate the customized weather derivative based on the weather contract type selection, the weather index term, and the payout term.

### BRIEF DESCRIPTION OF THE DRAWINGS

FIG. 1 is a block diagram of an exemplary environment in which embodiments of the present inventions may be practiced.

FIG. 2 is a block diagram of an exemplary derivative seller system.

FIG. 3 is a block diagram of an exemplary purchase engine of the derivative seller system.

FIG. 4 is a flowchart of an exemplary method for automated creation, pricing, and purchase, and settlement of the weather derivative.

FIG. 5 is a flowchart of an exemplary method for obtaining derivative terms.

FIG. 6 is a flowchart of an exemplary method for obtaining index terms for the weather derivative.

### DESCRIPTION OF EXEMPLARY EMBODIMENTS

Embodiments of the present invention provide a system and method for creating customized weather derivatives. A weather derivative is a commodity contract whose payout is based on a specified weather event (e.g., the number of days of snow in a particular location for one month). Weather derivatives may be used as risk-management instruments that can help buyers manage financial risk tied to the weather.

In various embodiments, a general weather derivative contract form is provided. A weather contract type selection within the general weather derivative contract form is received from a purchaser by a derivative seller system. A weather index term and a payout term based on the weather contract type selection are also received from the purchaser. The customized weather derivative based on the weather contract type selection, the weather index term, and the payout term is generated.

A general weather derivative contract form is a form that can be used to generate two or more different kinds of weather derivatives. In one example, the same general weather derivative contract form may be used to generate an HDD (i.e., heating degree day) weather derivative as well as a CDD (i.e., cooling degree day) weather derivative. In another example, the same general weather derivative contract form can be used to generate a weather derivative based on precipitation, snow, severe weather, and hot days. Those skilled in the art will appreciate that the general weather derivative contract form can be used to create many different kinds of weather derivatives.

In some embodiments, weather derivatives may be used to hedge against adverse weather. Adverse weather can be as simple as a rainy day or as destructive as a 6-month drought. If weather conditions can negatively impact a business, the business can purchase a weather derivative that will pay when the weather conditions occur, thus “hedging” the risk. As a result, hedging weather risk can decrease volatility of business profits.

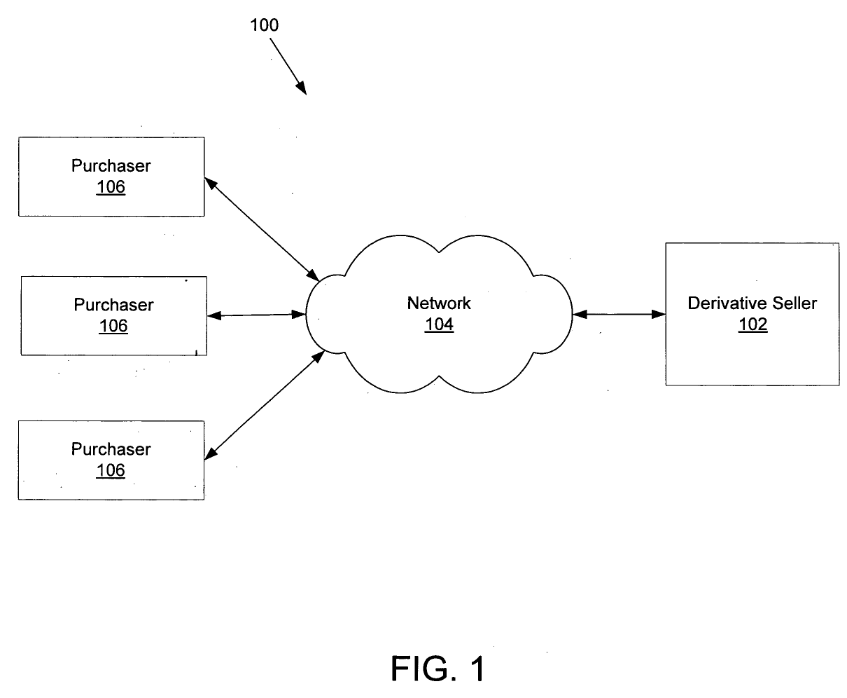

Referring to FIG. 1, an exemplary environment 100 in which embodiments of the present invention may be practiced is shown. The environment 100 comprises a derivative seller 102 coupled via a network 104 to a plurality of derivative purchasers 106. In exemplary embodiments, the network 104 may comprise the Internet. In other embodiments, the network 104 may comprise a local area network, a wide area network, a peer-to-peer network, the Public Switched Telephone Network, or any other network that facilitates communications between the derivative seller 102 and the purchaser(s) 106. In some embodiments, more than one network 104 and/or more than one type of network 104 may be utilized to allow the parties in the environment 100 to communicate with each other.

Referring to FIG. 1, an exemplary environment 100 in which embodiments of the present invention may be practiced is shown. The environment 100 comprises a derivative seller 102 coupled via a network 104 to a plurality of derivative purchasers 106. In exemplary embodiments, the network 104 may comprise the Internet. In other embodiments, the network 104 may comprise a local area network, a wide area network, a peer-to-peer network, the Public Switched Telephone Network, or any other network that facilitates communications between the derivative seller 102 and the purchaser(s) 106. In some embodiments, more than one network 104 and/or more than one type of network 104 may be utilized to allow the parties in the environment 100 to communicate with each other.

The derivative seller 102 sells weather derivatives. In exemplary embodiments, the purchaser 106 will directly access the derivative seller 102 via the network 104 to request a quote for the weather derivative. Should the purchaser 106 decide to purchase the weather derivative, the transaction may be completed with the derivative seller 102 via the same or alternative network 104.

For example, a purchaser 106 may access a website of the derivative seller 102. Via the website and the network 104 (i.e., the Internet), the purchaser 106 provides desired terms for the weather derivative. The desired terms are received by a coupled system, which will determine a price for the weather derivative in an automated manner. The price is provided to the purchaser 106 for review. In some embodiments, the purchaser 106 may adjust desired terms in order to obtain different price quotes. Should the purchaser 106 decide to buy the weather derivative, the transaction may be completed online via an exchange of digital agreements and digital signatures.

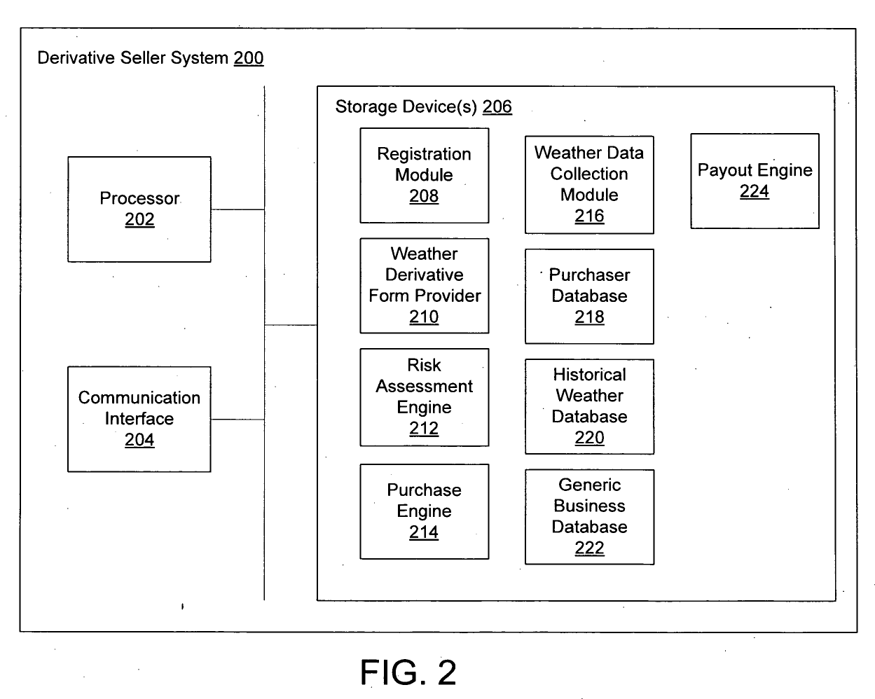

In an alternative example, the purchaser 106 may access the derivative seller 102 by phone via a PSTN. The terms are orally provided to an agent of the derivative seller 102 who inputs the desired terms into a coupled system (e.g., a derivative seller system further discussed in FIG. 2) in order to obtain a price quote. Should the purchaser 106 decide to buy the weather derivative, documents may be mailed, faxed, or e-mailed between the derivative seller 102 and the purchaser 106. Any mechanism may be utilized to facilitate the communication between the purchaser 106 and the derivative seller 102 and to transact the sale of the weather derivative without the use of a facilitator, broker, or exchange.

Through the purchase of a weather derivative, a business may, in some embodiments, seek to cover a negative impact of weather on revenue. For simplicity of discussion, the following description will be presented with reference to the customization of weather derivatives over an online network 104 (e.g., the Internet). However, it is understood that embodiments of the present invention may be applied to any type of weather derivative and any type of network 104.

It should be noted that FIG. 1 is exemplary. Alternative embodiments may contemplate modifications to the environment 100 but still be within the scope of present embodiments. For example, any number of purchasers 106 may be present in the environment 100. The purchaser 106 may comprise any individual or business entity which seeks to create and purchase a weather derivative.

Referring now to FIG. 2, a derivative seller system 200 is shown. The derivative seller system 200 comprises a processor 202, a communication interface 204, and at least one storage device 206. The communication interface 204 is configured to facilitate communications between the derivative seller system 200 and the purchasers 106. The storage devices 206 may comprise any type of device or memory that stores data. In exemplary embodiments, the storage device 206 comprises a registration module 208, a weather derivative form provider 210, a risk assessment engine 212, a purchase engine 214, a weather data collection module 216, a plurality of databases, and a payout engine 224. The databases may comprise a purchaser database 218, a historical weather database 220, and a generic business database 222.

The registration module 208 is configured to create and maintain an account with the derivative seller site (e.g., a website on an Internet) for the purchaser 106. Upon initial access or purchase of a weather derivative, the purchaser 106 may be requested to set up an account. The registration module 208 will collect data from the purchaser including name, address or location, and contact information (e.g., phone number, fax number, e-mail address, etc.). In some embodiments, the purchaser 106 may be allowed to input and store payment information, such as bank account routing information or credit card information. In exemplary embodiments, the information received from the purchaser 106 is stored in the purchaser database 218.

In order to purchase weather derivatives, in some embodiments, the purchaser 106 may be required to agree to an upfront agreement to attest to the purchaser's 106 eligibility or intent to purchase the weather derivatives. As such, an upfront agreement acknowledging eligibility may be presented via the registration module 208. The purchaser 106 will, in some embodiments, be required to provide a digital signature on the agreement. Alternatively, a paper agreement may be exchanged between the purchaser 106 and the derivative seller 102 during the account set-up or prior to any weather derivative transactions.

In some embodiments, an International Swaps and Derivatives Association (ISDA) Master Agreement may also be provided during the account set-up process. An acknowledgement of the receipt and review of the ISDA Master Agreement may be required. For example, a digital or real signature may be required on the ISDA Master Agreement before the purchaser 106 is allowed to purchase derivatives.

The weather derivative form provider 210 provides a general weather derivative contract form. As discussed previously, the general weather derivative contract form is a form that, once completed and executed, creates a weather derivative for two or more different types of weather risks (e.g., precipitation and HDD weather derivatives.)

In various embodiments, the weather derivative form provider 210 provides the general weather derivative contract form to the user of the derivative seller system 200. In other embodiments, the weather derivative form provider 210 provides one or more forms via html to be filled out by the user of the derivative seller system 200. Once responses are received, the weather derivative form provider 210 can populate the general weather derivative contract form with information received from the user and prepare the form for execution to create the weather derivative.

The weather derivative form provider 210 can request information based on previous responses. In one example, the weather derivative form provider 210 can request a weather contract type selection. The weather contract type selection is the weather that is the basis for the weather derivative. In one example, the weather contract type selection is temperature for an HDD weather derivative. In another example, the weather contract type selection is precipitation for a “Rainy Day” derivative. The weather derivative may be based on a variety of different weather conditions, including, but not limited to, windspeed, precipitation, snow, sunlight, and temperature. In some embodiments, the weather derivative is based on extreme or severe weather, such as hurricanes, floods, blizzards, lightning, tornadoes, high winds, hail, drought, severe cold, or excessive heat.

Once the weather contract type selection is received, the weather derivative form provider 210 can request a weather index term and a payout term based on the weather contract type selection received. A weather index term comprises the operation used to calculate a weather index. The weather index is a metric that is used to determine the payout of a weather derivative. In one example, the weather index is the total number of days that the threshold is met (e.g., the weather index is five which indicates that there were five days with temperatures above the threshold of 65°). The payout term is a term that relates to the payout of the weather derivative contract. In some embodiments, the payout term determines whether the weather derivative pays out in a binary or scaling fashion.

Many different operations may be used to calculate the weather index including, but not limited to, a summation operation, an average operation, a maximum operation, and a minimum operation. With a sum operation, the weather index may be the sum of all the daily values. A daily value is a quantitative metric that is the result of comparing raw weather measurements to a reference value.

In some embodiments, the daily value is a binary value indicating a “1” when the threshold value (e.g., 65° degrees) is met and a “0” when the threshold value is unmet. In one example, a purchaser purchases a weather derivative based on temperatures above 65° degrees in Philadelphia, Pa., from Jul. 1, 2007, through Jul. 3, 2007. The highest temperature per day reached during this time was 67°, 71°, and 58°, respectively. The daily values for July 1 through July 3 are 1, 1, and 0. As a result, there may be a payout for July 1 and July 2, but no payout for July 3.

In other embodiments, the daily value is not binary. In an example, the purchaser purchases a single day weather derivative based on temperatures below 45° degrees in Dallas, Tex. If the temperature for that day was 33° degrees, the daily value may be 12 (e.g., 45−33=12).

Those skilled in the art will appreciate that the daily value can be any positive or negative metric used to measure whether a qualitative or quantitative threshold is reached and/or the degree to which the threshold was surpassed.

When the daily values are binary, the weather index term of summation may result in a summation of all days that meet or exceed the threshold. In one example, the purchaser purchases a weather derivative with binary daily values for every day it rains over ½ an inch in Des Moines, Iowa, from Jul. 1, 2007, through Jul. 3, 2007. The daily values for July 1 through July 3 may be 1, 0, and 1, respectively, which indicates rain equal to or over ½ an inch for two of the three days. The weather index, with a summation operation, is equal to 2.

In another embodiment, the weather index may be calculated with an average operation. In an example, daily values can be amounts by which the temperatures are equal to or above 60° degrees. If the measured temperature is below 60° degrees, the daily value is 0. The daily value in this example can be 0, 0, 0, 4, and 0, which indicates that there was one day during the duration of the weather derivative that the temperature exceeded 60° (i.e., 64° degrees). The weather index is the average of these five numbers, which is 0.8.

In other embodiments, the weather index may be calculated with a maximum or minimum operation which indicates the maximum or minimum amount the threshold is exceeded during the duration of the contract. In one example of a maximum operation, the daily values are the amount by which the measurements fall below 60° degrees. The daily values for the duration is 7, 2, 0, 0, and 5 (e.g., on the first day, the temperature was 53° degrees.) The weather index is the maximum of these numbers which is 7. Alternately, for a minimum operation, the daily values may be the smallest amount by which the threshold is met. For example, the weather derivative is based on any amount of precipitation. The daily values in this example for the duration of the weather derivative are 0.7, 0.2, 0, 1, and 0.4 which indicates that there was no precipitation on the second day. The weather index is the minimum of these numbers which is 0.

Those skilled in the art will appreciate that the user of the derivative seller system 200 can be a purchaser (e.g., a user accessing the derivative seller system 200 over the Internet) or an agent (e.g., a user that accesses the derivative seller system 200 while speaking to a potential derivative purchaser over the telephone.)

The exemplary risk assessment engine 212 is configured to analyze purchaser revenue-related data to determine sensitivity of the purchaser's business to weather. More particularly, the risk assessment engine 212 provides guidance as to how certain types of weather conditions impact revenue for the business. It should be noted that the risk assessment engine 212 is option in some embodiments.

In various embodiments, the risk assessment engine 212 performs one or more different risk assessment types. In one embodiment, an uploadable revenue report (e.g., Quickbook report or Excel spreadsheet) may be uploaded to the derivative seller system 200. The revenue and corresponding dates that the revenue are generated are correlated to historical weather (e.g., from the historical weather database 220) for each day. As such, the risk assessment engine 212 correlates the business revenue with weather patterns to determine what the purchaser business is most sensitive to and their relationship to temperature and precipitation. This type of risk assessment is a customized risk assessment.

In an embodiment not utilizing uploaded purchaser financial data, the risk assessment engine 212 requests the purchaser 106 to enter financial information in order to perform a simplified risk assessment. The entered financial information may comprise purchaser location, average annual revenue, and an indication as to whether weekends are included in the calculation of the annual revenue. The purchaser 106 is then provided a series of sliders through which the purchaser 106 can indicate (e.g., by sliding along a scale) seasonality of their business (e.g., weekly, monthly, or quarterly). The purchaser 106 may, optionally, be provided a series of sliders or a graph, which allow the purchaser 106 to estimate how their business does based on temperature and/or precipitation.

Based on all the entered financial data, an artificial financial performance report based on weather is generated. In exemplary embodiments, the risk assessment engine 212 accesses historical weather data for a particular amount of time (e.g., 10 years). Financials are then recreated given the entered financial data. The artificial financial performance is generated based on the recreated revenue over the particular amount of time based on the historical weather data. For example, the risk assessment engine 212 may determine that on average the business is going plus or minus a certain dollar amount per day based on the temperature for that particular day. In another example, the risk assessment engine 212 may determine that a business seems to suffer the greatest financial loss when a certain temperature is exceeded. Based on the analysis, an assessment of the business' risks in relations to certain weather conditions is determined.

In yet another embodiment, the risk assessment engine 212 may perform a generic assessment for the purchaser 106. In this embodiment, the risk assessment engine 212 will obtain from the purchaser 106 a given industry, zip code, and average annual revenue. Base on this data and using data derived from other sources (e.g., saved in the generic business database 222), the business' susceptibility to weather is derived based on businesses of the same size in the same area. In some embodiments, qualitative examples of how the purchaser's business may be affected by weather may be provided. A further discussion of the risk assessment engine 212 is provided in related U.S. patent application Ser. No. 11/611,111 entitled “Systems and Methods for Automated Weather Risk Assessment,” which is incorporated by reference.

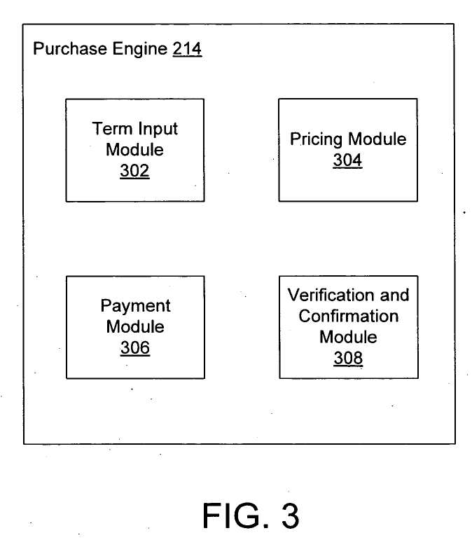

The purchase engine 214 is configured to determine, in an automated manner, a price for a weather derivative. Furthermore, the purchase engine 214 may complete a transaction for the sale of the weather derivative. The purchase engine 214 will be discussed in more detail in connection with FIG. 3.

The weather data collection module 216 is configured to obtain weather information from a plurality of weather stations. The weather information is then used to determine if terms of a weather derivative are met which require a payout or settlement on the weather derivative. In some embodiments, the weather stations utilized are owned and run by the National Weather Service. Data feeds from the National Weather Service are provided to a third party, which cleans and audits the information. Thus, an independent third party audits the data for accuracy. The weather information may be accessed in real-time. Alternatively, the weather information may be stored in the historical weather database 220 for later review.

The generic business database 222 stores general business data including location, size, and average revenue of a plurality of businesses. The general business data may be utilized by the risk assessment engine 212 for performing the generic assessment of a purchaser's business.

In exemplary embodiments, the payout engine 224 is configured to determine, in an automated manner, whether the weather derivative requires settlement (i.e., payout). If settlement is required, then the payout engine 224 will process the payout (e.g., credit the purchaser's account). In general, the payout engine 224 reviews data received at predetermined times to determine if any triggers, as defined by the derivative terms, have been exceeded. For example, in the weather derivative embodiment, weather data may be received daily via the weather data collection module 216. The weather data is then used by the payout engine 224 to determine if various triggers, as defined by the terms of the derivative, have been reached. If a payout trigger is exceeded, then a payment will be made to the purchaser.

In various embodiments, the payout engine 224 determines the payout based on the daily values and one or more daily terms. As previously discussed, the payout term is a term that relates to the payout of the weather derivative contract. In some embodiments, the payout term determines when the weather derivative pays. In some examples, the payout term indicates an incremental payout value per tick of the weather index, a binary payout if the weather index is above a threshold, or a binary payout if the weather index is below a threshold.

An incremental payout per tick indicates that the payout of the weather derivative grows incrementally with the weather index. The purchaser may choose a payment increment (e.g., a “tick”) as well as the number of ticks before the weather derivative begins to pay out (commonly referred to as a “strike”.) A tick can represent one day (e.g., a cold or rainy day), one inch of precipitation, or one degree Fahrenheit, for example. In various embodiments, if the weather index is greater than the strike, then the weather derivative pays out. Alternately, in other embodiments, the weather derivative pays out if the weather index is less than or equal to the strike.

In some embodiments, the payout term indicates a binary payout above a threshold. In one example, the purchaser can choose a payout amount and a binary threshold (i.e., a strike amount). The weather derivative can pay a lump sum if the weather index exceeds the strike. In other embodiments, the payout term indicates a binary payout below a threshold. For example, the weather derivative may pay a lump sum if the weather index is below the strike value.

Those skilled in the art will appreciate that there may be many different payout terms that determine when and how a weather derivative pays. The weather index term can also include the maximum amount the weather derivative would payout.

In one example, the payout terms indicate an incremental payout with a maximum payout of $2,000. If the strike value is equal to 12, then a weather index equal to 23 may payout $100×(23−12)=$1,100.

In another example, the payout terms indicate a binary payout above a threshold with a strike value of 12. If the weather index is equal to 23, the weather index is larger than the strike value, so the weather derivative may payout a lump sum of the maximum payout (e.g., $100).

FIG. 3 is a block diagram of the exemplary purchase engine 214. The purchase engine 214 comprises a term input module 302, a pricing module 304, a payment module 306, and a verification and confirmation module 308. Alternative embodiments may comprise more, less, or functionally equivalent components and still be within the scope of embodiments of the present invention.

The term input module 302 is configured to obtain weather derivative terms utilized to customize and price the weather derivative and determine payout. In the weather derivative embodiment, weather derivative terms may comprise the weather contract type selection, the weather index term, and the payout term.

The term input module 302 may be further configured to receive a duration of contract term and a location term. The duration of contract term specifies the length of the weather derivative. In one example, the duration of contract term begins at 12:00 AM on Jul. 16, 2007, and ends 12:00 AM Aug. 1, 2007. In some examples, the duration of contract term is defined by minutes, hours, days, weeks, or years. In some embodiments, the duration of contract term may specify that weekends be included during the duration, that only weekends are included during the duration of the weather derivative, or all days of the week(s). Similarly, the duration of contract term may specify that holidays be included or excluded during the duration. The location term indicates the weather station location for which measurements will be derived and the weather derivative is based upon (e.g., Chicago Midway Airport, Illinois.)

Based on the weather derivative terms, the term input module 302, the pricing module 304, or other module of the purchase engine 214 generates the weather derivative. The pricing module 304 also determines a price for the weather derivative in an automated manner. In exemplary embodiments, the pricing module 304 will take into consideration factors such as expected net payout on the derivative and a risk premium. The expected net payout may be based, at least in part, on historical data (e.g., historical weather data). The expected net payout may also be based on weather predictions (e.g., by modeling or simulating weather behavior and factoring in increased risk based on future uncertainty which may increase depending on how far in the future the weather derivative is expected to cover). The risk premium is a function of a payout risk (i.e., calculated standard deviation of payout) and portfolio risk (i.e., incorporated risk of existing derivatives and difference in the risk due to the present derivative). The price quote is then presented to the purchaser 106.

If the purchaser 106 decides to purchase the weather derivative, payment information is obtained and processed by the payment module 306. In some embodiments, payment information may have been previously provided and stored in the purchaser's account. In these embodiments, the payment information will be accessed and automatically processed. In other embodiments, the purchaser 106 provides the payment information at the time of purchase. For example, the purchaser 106 may provide a wire transfer, credit card charge authorization, an electronic fund transfer, or any other payment mechanism authorization.

The exemplary verification and confirmation module 308 verifies that payment is received and that all requirements have been complied with in order to complete the sales transaction. In some embodiments, an acknowledgement that the purchaser 106 is qualified to purchase the weather derivative may be required or reviewed. This qualification process may occur prior to the receipt of payment information via the payment module 306.

In some embodiments, a verification of acceptance of the ISDA Master Agreement is also performed by the verification and confirmation module 308. In some embodiments, the ISDA Master Agreement is referenced, which the purchaser 106 reviewed upon account set-up. In other embodiments, the ISDA Master Agreement is provided to the purchaser 106 for digital signature at the time of purchase. Upon completion of sale, a purchase confirmation is provided to the purchaser 106 by the verification and confirmation module 308.

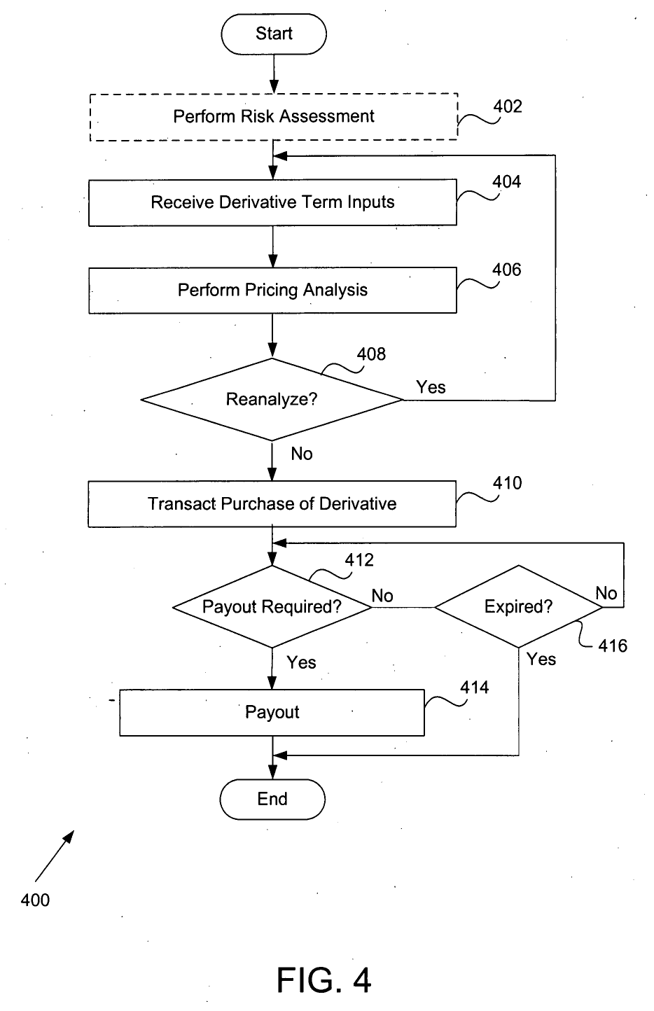

FIG. 4 illustrates a flowchart of an exemplary method for automated creation, pricing, purchase, and settlement of a weather derivative. In optional step 402, a risk assessment is performed. The risk assessment may be performed for any purchaser 106 that is unsure as to how weather, for example, impacts their business. The risk assessment will provide the purchaser 106 with an assessment of the business' sensitivity to weather as well as the weather conditions that impact the business.

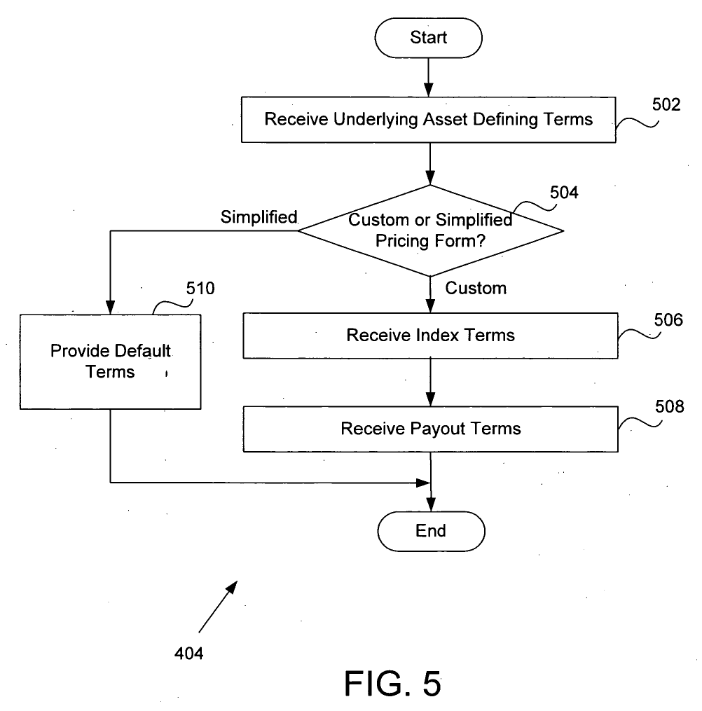

In step 404, derivative term inputs are received from the purchaser 106. In exemplary embodiments, the term input module 302 and/or the weather derivative form provider 210 will provide a user interface through which the derivative terms may be entered or selected (e.g., from a pull down menu) by the purchaser 106. Step 404 will be discussed in more detail in connection with FIG. 5.

Based on all the derivative terms received in step 404, a weather derivative is generated and a pricing analysis is performed in step 406. The pricing analysis is performed by the pricing module 304 in an automated manner. In one embodiment, the price of the weather derivative is based on expected payout and some risk premium. The risk premium is a function of a payout risk and a portfolio risk. The payout risk comprises a calculated standard deviation of payout. The portfolio risk incorporates risk of existing derivatives for the derivative seller 102 and a difference in that risk due to the new weather derivative currently being priced. As a result, a price for the customized derivative is automatically generated and output to the purchaser 106. It should be noted that the price is non-negotiable in accordance with exemplary embodiments.

In step 408, the purchase engine 214 determines if the purchaser 106 requests a reanalysis of the weather derivative. For example, the purchaser 106 may want to change one or more weather derivative terms in order to compare pricing for different weather derivatives. If reanalysis is requested, the method returns to step 404.

Should the purchaser 106 decide to purchase the weather derivative at the quoted price, the purchase transaction is performed in step 410. Upon receiving a request to purchase the weather derivative, the verification and confirmation module 308 can verify that the purchaser 106 is qualified to purchase the weather derivative (e.g., review the purchaser's account to determine if the purchaser 106 has previously acknowledged their eligibility or request the acknowledgment of eligibility from the purchaser 106 at the time of purchase). In some embodiments, an acknowledgement of the ISDA Master Agreement is also verified.

The payment module 306 accesses payment information. In some embodiments, the payment module 306 will access the payment information stored in the purchaser's account. In other embodiments, the purchaser 106 will be requested, at the time of the purchase, to provide payment information.

Upon receipt of the various verifications and approval of the payment, the purchase of the weather derivative is completed. In exemplary embodiments, a confirmation is sent to the purchaser 106 by the verification and confirmation module 308. The confirmation may be sent via e-mail, fax, mail, provided on a page of the website, or any combination of these methods.

In step 412, the payout engine 224 determines if a payout (i.e., settlement) on the weather derivative is required. In exemplary embodiments, the payout engine 224 reviews data received at predetermined times to determine if any triggers (e.g., based on the weather index term and daily values), as defined by the derivative terms, have been exceeded. For example, in the weather derivative embodiment, weather data may be received at a predetermined time (e.g., daily) by the weather data collection module 216. The weather data is then used by the payout engine 224 to determine if various triggers, as defined by the terms of the weather derivative, have been reached.

If a payout trigger is exceeded, then settlement may be automatically performed by the payout engine 224 in step 414. In some embodiments, the payout engine 224 will provide a credit to the purchaser's account with the derivative seller 102. In other embodiments, funds may be transferred to an account at a financial institution designated by the purchaser. According to some embodiments, the payout may be made over a period of time, as defined by payout terms of the weather derivative.

If the payout trigger is not exceeded and payout is not required in step 412 based on the data received at the predetermined time, then a determination may be made in step 416 as to whether the weather derivative is still active. If the weather derivative, based on the derivative terms, has not expired, then the payout engine 224 will continue to monitor data as it is received to determine if settlement is required.

Referring now to FIG. 5, a flowchart of an exemplary method for receiving derivative term inputs (step 404) is shown. These derivative term inputs are received by the term input module 302, and utilized to create and price the weather derivative. The derivative terms inputs are also utilized to determine if settlement upon a purchased weather derivative is required. In step 502, the term input module 302 receives the weather contract type selection defining the basis for the weather derivative.

In some embodiments, the duration of contract term is received. The duration of contract term may comprise start and end dates for the weather derivative. In various embodiments, the purchaser 106 may manually enter the dates, select the dates from a graphical calendar, or use one or more pull-down menus to select the month, day, and year of the start and dates. In other embodiments, the purchaser 106 may enter a start date and select a derivative length (e.g., six months, one year, etc.). The weather derivative may also comprise a term length (e.g., one day, six months, one year, etc.).

The term input module 302 may also provide a weekday/weekend selection. In exemplary embodiments, the purchaser 106 has the option of pricing a weather derivative based on weekdays only, weekends only, full week (i.e., weekday and weekend), or certain days (e.g., Thursday through Sunday). This option allows a purchase 106 that is, for example, a weekday or weekend dependent business to limit their coverage to a portion of the week that is more important for their business. For example, an amusement park may be interested in a weather derivative that only covers the Friday through Sunday during non-summer months since the bulk of their business occurs on those days during these months, whereas a restaurant in a business park may be interested in a weather derivative that only covers weekdays since they have limited business on the weekends. These selection(s) may be received by the derivative seller system 200 as duration of contract term(s).

In various embodiments, the location term may be received. The location term may comprise a selection of, for example, a weather station closest to the location of the purchaser. For example, the purchaser 106 may scroll through a pull-down menu of weather stations and select the closest one. Alternatively, the purchaser 106 may provide a zip code or a city and state of their business, and the term input module 302 will return a listing of one or more weather stations. If only one weather station is returned, the weather station is automatically selected. However, if more than one weather station is returned, the purchaser 106 may have the option of selecting one weather station from the list.

In exemplary embodiments of the present invention, the purchaser 106 further customizes the weather derivative. As such specific, customized terms for the purchaser 106 will be requested by the term input module 302 as will be discussed in connection with steps 506 and 508 below. However, in alternative embodiments, default terms may be provided to the purchaser 106. As such, in optional step 504, the purchase engine 214 determines if the purchaser 106 is utilizing a custom or simplified pricing interface, which will determine what further derivative term inputs are needed from the purchaser 106. The custom pricing interface will allow the purchaser 106 to enter or select the weather index terms and various payout terms. In contrast, the simplified pricing interface will provide a default set of terms for the index and payout terms based on simple inputs.

If the custom pricing interface is used, further derivative terms are directly requested from the purchaser 106. In step 506, weather index terms and the weather contract type selection are requested and received from the purchaser. The terms and selection may comprise one or more weather parameter(s) the weather derivative is to be priced upon. For example, the purchaser 106 may desire to price the weather derivative based on maximum temperature, minimum temperature, or average temperature.

The payout term may also comprise threshold terms. The threshold terms may comprise a threshold value, a threshold measurement type, and a threshold trigger. The threshold value may comprise any value. For example, the threshold value may be two inches of rain or a temperature of 65° degrees. The threshold measurement type may be based on a sum of daily values, an average value, a maximum value over a particular period of time or term of the weather derivative, or a minimum value over a particular period of time or term of the weather derivative. In exemplary embodiments, the purchaser 106 selects one of these four threshold measurement types.

The threshold trigger may comprise a measurement above the threshold value (e.g., any day it rains over two inches), a measurement below a threshold value (e.g., any day the temperature is below 65° degrees), or a binary trigger (e.g., any day that it rains regardless of the amount of rain). Any condition which exceeds the threshold trigger will result in a tick value. Ticks may be based on daily values. For example, every measurement of rain above the threshold value zero (i.e., the threshold trigger) in a day results in a weather parameter tick. Thus, one inch is equal to one tick, while 0.45 inches is equal to 0.45 ticks. A similar weather parameter tick mechanism applies to temperature. For example, one degree over a threshold temperature results in one tick. In some embodiments, daily ticks are used instead of the weather parameter tick. For example, any day that there are more than two inches of precipitation measured results in a tick value for that day.

In step 508, the term input module 302 receives payout terms. The payout terms may comprise a payout amount, a payout trigger type, and a payout trigger. The payout amount indicates an amount of money that the purchaser 106 will receive if the payout trigger (i.e., strike) is reached or exceeded. The payout trigger is a condition that must occur or be exceeded to cause a payout on the weather derivative. The payout trigger is correlated to the tick values. In exemplary embodiments, the payout trigger may be based on the payout trigger type. The payout trigger type may be based on the occurrence of any single tick (e.g., payout any day that it rains more than five inches), per tick of a threshold trigger (e.g., pay $100 per inch of rain), or a sum of all ticks (e.g., payout if it rains for more than 50 days during the term of the weather derivative). In further embodiments, the payout terms may comprise a payout timeline (e.g., for payouts over a period of time).

If the simplified pricing interface is selected, default weather index terms and payout terms are provided to the purchaser 106 in step 510 based on, for example, an industry and/or a size of the business input as provided by the purchaser 106. Alternative embodiments may require other simple inputs from the purchaser 106 to determine the default terms. The default terms may be based on derivative terms that are most popular or most requested by businesses having similar revenue, location, and/or in the same industry. In some embodiments, a plurality of default terms may be provided to the purchaser 106, from which a selection may be made. For example, a set of default terms may be provided to the purchase 106 via one or more fields, each having a pull down menu. If the purchaser 106 desires to change the default term, the purchaser 106 may activate the pull down menu and select a different default term. If the purchaser 106 agrees with using the default terms, then the purchaser 106 may just request a price quote via activating a corresponding button. In other embodiments, the default terms may be directly edited (e.g., the purchaser 106 enters a different value in a field where the fixed input is presented) by the purchaser 106.

It will be appreciated by those skilled in the art that the weather derivative form provider 210 may perform the functions described in FIG. 5 as being performed by the term input module 302.

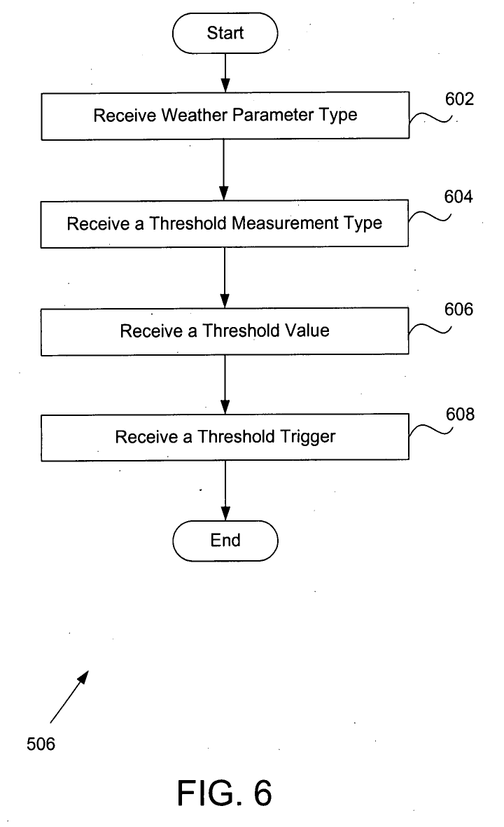

Referring now to FIG. 6, a flowchart for providing customized weather index terms (step 408) is shown. In step 602, a weather derivative contract type selection is received. For example, the purchaser 106 may desire to price the weather derivative based on precipitation; maximum temperature, minimum temperature, average temperature, snowfall amount, or wind conditions. The weather derivative contract type selection can be based on any type of weather condition.

The weather index term comprising a threshold measurement type may also be received in step 604. The threshold measurement type may be based on a sum of daily values, an average value, a maximum value over a particular period of time or term of the weather derivative, or a minimum value over a particular period of time or term of the weather derivative. In exemplary embodiments, the purchaser 106 selects one of these four threshold measurement types. Other threshold measurement types may also be utilized.

In step 606, a threshold value is received from the purchaser 106. The threshold value may comprise any value. For example, the threshold value may be ten inches of snow or a temperature of 65° Fahrenheit.

A threshold trigger (e.g., payout term) is received in step 608. The threshold trigger may comprise a measurement above the threshold value (e.g., any day it snows over ten inches), a measurement below a threshold value (e.g., any day the temperature is below 65° Fahrenheit), or a binary trigger (e.g., any day that it snows regardless of the amount of snow). Any condition which exceeds the threshold trigger will result in a “tick” value. Ticks may be based on daily values. For example, every measurement of rain above the threshold value zero (i.e., the threshold trigger) in a day results in a weather parameter tick. Thus, one inch is equal to one tick, while 0.45 inches is equal to 0.45 ticks. A similar weather parameter tick mechanism applies to temperature, snowfall, or any other weather condition. For example, one degree over a threshold temperature results in one tick. In some embodiments, daily ticks are used instead of the weather parameter tick. For example, any day that is rains for more than 2 inches results in a tick value for that day.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for creating a customized weather derivative, the method comprising:
providing a general weather derivative contract form;
receiving a weather contract type selection within the general weather derivative contract form;
receiving a weather index term and a payout term based on the weather contract type selection; and
generating the customized weather derivative based on the weather contract type selection, the weather index term, and the payout term.

2. The method of claim 1 further comprising receiving a location term and a duration of contract term.

3. The method of claim 2 wherein the location term comprises a weather station location.

4. The method of claim 2 wherein the duration of contract term comprises a weekday/weekend selection.

5. The method of claim 1 wherein the weather index term comprises a weather parameter type.

6. The method of claim 1 wherein the weather index term comprises threshold terms.

7. The method of claim 1 wherein the payout term comprises a payout amount for the customized weather derivative.

8. The method of claim 1 wherein the payout term comprises a payout trigger term.

9. The method of claim 1 further comprising performing a pricing analysis based on the weather contract type selection, the weather index term, and the payout term.

10. A machine readable medium having embodied thereon a program comprising instructions, the instructions providing a method for creating a customized weather derivative in a network, the method comprising:
providing a general weather derivative contract form;
receiving a weather contract type selection within the general weather derivative contract form;
receiving a weather index term and a payout term based on the weather contract type selection; and
generating the customized weather derivative based on the weather contract type selection, the weather index term, and the payout term.

11. The computer readable medium of claim 10 wherein the method further comprises receiving a location term and a duration of contract term.

12. The computer readable medium of claim 11 wherein the location term comprises a weather station location.

13. The computer readable medium of claim 11 wherein the duration of contract term comprises a weekday/weekend selection.

14. The computer readable medium of claim 10 wherein the weather index term comprises a weather parameter type.

15. The computer readable medium of claim 10 wherein the weather index term comprises threshold terms.

16. The computer readable medium of claim 10 wherein the payout term comprises a payout amount for the customized weather derivative.

17. The computer readable medium of claim 10 wherein the payout term comprises a payout trigger term.

18. The computer readable medium of claim 10 wherein the method further comprises performing a pricing analysis based on the weather contract type selection, the weather index term, and the payout term.

19. A system for creating a customized weather derivative, the system comprising:
a means for providing a general weather derivative contract form;
an interface configured to receive a weather contract type selection, a weather index term and a payout term based on the weather contract type selection; and
a processor configured to generate the customized weather derivative based on the weather contract type selection, the weather index term, and the payout term.

20. The system of claim 19 wherein the interface is further configured to receive a location term and a duration of contract term.

21. The system of claim 20 wherein the location term comprises a weather station location.

22. The system of claim 20 wherein the duration of contract term comprises a weekday/weekend selection.

23. The system of claim 19 wherein the weather index term comprises a weather parameter type.

24. The system of claim 19 wherein the weather index term comprises threshold terms.

25. The system of claim 19 wherein the payout term comprises a payout amount for the customized weather derivative.

26. The system of claim 19 wherein the payout term comprises a payout trigger term.

27. The system of claim 19 wherein the processor is further configured to perform a pricing analysis based on the weather contract type selection, the weather index term, and the payout term.
